(19) United States
(12) Patent Application Publication
(10) Pub. No.: US 2003/0217301 A1
(43) Pub. Date: Nov. 20, 2003

(54) Method and apparatus for transmitting side-band data within a source synchronous clock signal

(76) Inventors: Paul S. Levy, Chandler, AZ (US); Karl H. Mauritz, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/150,316

(22) Filed: May 16, 2002

(51) Int. Cl. G06F 1/12; H04L 5/00

(52) U.S. Cl. 713/400

(57) ABSTRACT

In a source synchronous interface between two devices, the transmitting device inserts side-band data into a clock signal and transmits to the other device the clock signal and one or more additional signals including data. The side-band data corresponds to the data. The receiving device extracts the side-band data from the received clock signal.

### FIELD

Embodiments of the invention relate generally to chip-to-chip communication and, more particularly, to a method and apparatus for transmitting side-band data within a clock signal of a source synchronous interface.

### BACKGROUND

Integrated circuit (IC) devices—such as controllers, memory devices, processing devices, as well as other IC components—are typically coupled to one another by a bus. A typical bus comprises one or more signal lines that link two or more IC devices or other components. A bus signal line may comprise any suitable conductive path (e.g., a conductive trace), and such a signal line may carry data, address information, or control information, which are generally in a binary format.

A conventional type of bus commonly used for inter-chip communication is a synchronous bus. For components coupled with a synchronous bus, the components transmit and receive signals (e.g., data, addresses, control information, etc.) to and/or from the bus in synchronism with a clock signal provided by a central, or system, clock. A transmitting device would place a data signal onto the bus at a time proximate the rising edge of a clock cycle, and a receiving device would latch the data signal from the bus at a time proximate the rising edge of the next clock signal. A synchronous bus is, however, susceptible to clock skew, wherein a first component perceives the rising edge of a clock cycle at a different moment in time than a second component perceives the rising edge of that clock cycle. Clock skew occurs because the conductive traces coupling a system clock to the various components linked with a bus may not be precisely matched (e.g., the conductive traces may have different lengths), thereby resulting in varying times-of-flight between the system clock and the components on the bus. To compensate for clock skew, tolerances are typically built into the bus system. For example, the system clock frequency may be lowered, such that a large time window is available for receiving signals from the bus.

To overcome the inherent frequency limitation of synchronous buses, a “source synchronous” interface may be used. Generally, a source synchronous interface is one in which a data signal and an accompanying clock signal are sent from a transmitting device to a receiving device, and the clock signal is used by the receiving device to latch the accompanying data. A source synchronous interface interlinking one device with a second device typically comprises a plurality of data lines and a dedicated clock or strobe line (or lines). It is generally assumed (with reasonable accuracy) that, given the same material and layout constraints, a data signal propagating over a data line and a clock signal propagating over the strobe line will arrive at the receiving device at the same, or nearly the same, time. Thus, a source synchronous interface negates the inherent limitations arising from the time-of-flight discrepancies present in synchronous buses.

When information is exchanged between two devices, it is often times necessary for the transmitting device to provide the receiving device with additional data that specifies the type or class of information that is being sent. This type or class information—which is commonly referred to as “side-band” data—may specify, for example, whether the transmitted data is header information, address data, control information, credit information (e.g., as used in credit-based communications), or data. There is generally a timing relationship between the side-band data and the underlying data that it describes (e.g., the side-band data may indicate start-of-address, start-of-data, etc.). Side-band data is often transmitted in the form of a “token.” A token is a symbol (i.e., a pre-defined bit pattern) that indicates a specific action that is to be taken with respect to any received data accompanying the token. By way of example, a token may indicate to the receiving device that address data is now being transmitted and should be processed accordingly.

For a source synchronous interface, side-band data (e.g., a token) is generally transmitted over one of the interface's data lines. Thus, when transmitting information over a source synchronous interface, at least one data line is utilized to transmit the side-band data in synchronism with the underlying data, thereby reducing the bandwidth of the source synchronous interface. To increase bandwidth, additional data lines are needed to handle the side-band data, which also consumes more on-chip “real estate.” This need for additional signal paths is especially problematic for a source synchronous interface, because additional real estate must already be devoted to the dedicated strobe line (or lines), which are generally utilized only for transmitting a clock signal. Also, for high frequency applications, more signal lines is usually undesirable, as frequency effects (e.g., induced currents) become significant and may impede performance.

### BRIEF DESCRIPTION OF THE DRAWINGS

FIG. 1 is a schematic diagram illustrating two IC devices coupled by an embodiment of a source synchronous interface.

FIG. 2 is a schematic diagram illustrating an exemplary clock signal and an exemplary data signal in a conventional source synchronous interface.

FIG. 3 is a schematic diagram illustrating an exemplary clock signal with side-band data and an exemplary data signal in an embodiment of a source synchronous interface.

FIG. 4 is a schematic diagram illustrating an embodiment of interface circuitry, as may be found in one of the IC devices shown in FIG. 1.

FIG. 5 is a schematic diagram illustrating an exemplary clock signal with side-band data, an exemplary blanking signal, the exemplary clock signal with no side-band data, the side-band data signal, and an exemplary data signal.

### DETAILED DESCRIPTION

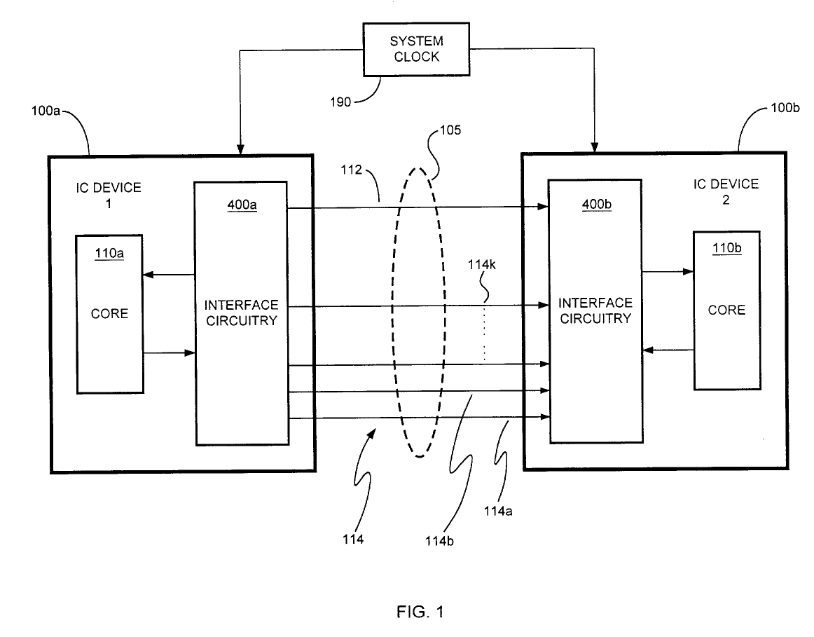

Referring to FIG. 1, a first integrated circuit (IC) device 100a is coupled to a second IC device 100b by a bus 105. Each IC device 100a, 100b may receive a system clock signal from a system clock 190. The IC devices 100a, 100b may each comprise any type of integrated circuit device, such as a controller (e.g., a memory controller), a memory device (e.g., a dynamic random access memory, or DRAM), or a processing device (e.g., a microprocessor, an application specific integrated circuit, or ASIC, etc.). By way of example, the first IC device 100a may comprise a memory controller and the second IC device 100b a DRAM chip. Further, each IC device 100a, 100b may comprise a single IC chip or, alternatively, each IC device 100a, 100b may comprise a number of IC chips that are interconnected and/or assembled to form a single component.

The IC device 100a includes a core 110a coupled with interface circuitry 400a and, similarly, the IC device 100b includes a core 110b coupled with interface circuitry 400b. The interface circuitry 400a of first IC device 100a is coupled via bus 105 with the interface circuitry 400b of second IC device 100b. The core 110a, 110b of each IC device 100a, 100b, respectively, is intended to represent any type of logic circuitry, memory circuitry, processing circuitry, or other functional circuitry, and it should be understood that the embodiments described herein are not limited to any particular type of IC device or architecture.

The bus 105 provides a strobe or clock line (or lines) 112 and a number of data lines 114, including data lines 114a, 114b, . . . , 114k. It should be understood that the IC devices 100a, 100b may be coupled by any suitable number of data lines 114 and by any suitable number of strobe lines 112 (e.g., two or more strobe lines). Each of the strobe line 112 and data lines 114a-k may comprise any suitable conductive path (e.g., a conductive trace), any suitable optical path (e.g., an optical fiber), or a combination thereof. Further, each of the strobe and data lines 112, 114a-k may comprise a differential line.

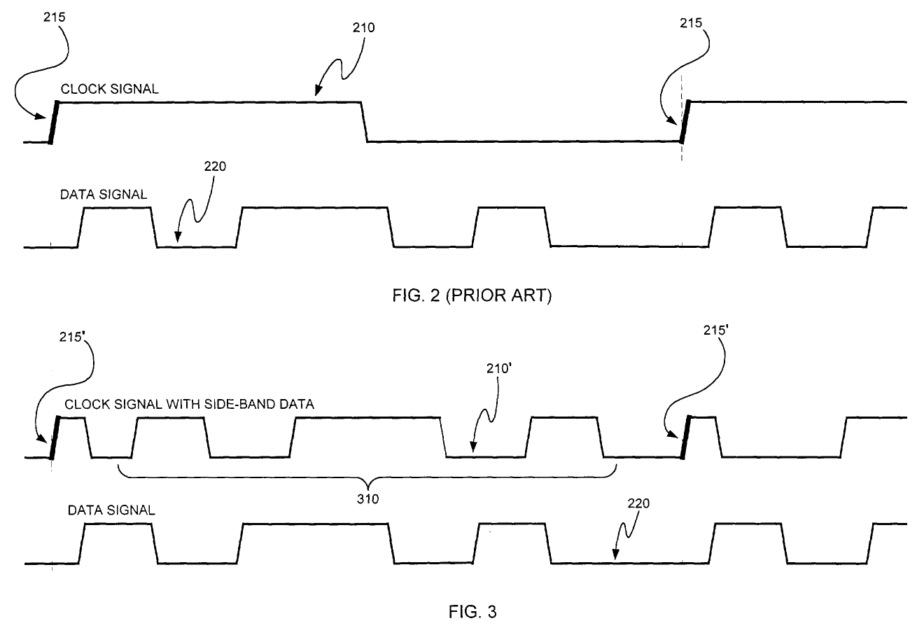

The interface circuitry 400a, 400b of each of the IC devices 100a, 100b, in conjunction with the bus 105 (e.g., strobe line 112 and data lines 114a-k), provide a source synchronous interface between the IC devices 100a, 100b. As set forth above, a conventional source synchronous interface is one in which a data signal and an accompanying clock signal are sent from a transmitting device to a receiving device, and the clock signal is used by the receiving device to latch the accompanying data. Referring to FIG. 2, if the first IC device 100a were, for example, to transmit a data signal 220 to the second IC device 100b, the first IC device 100a would transmit the data 220 over one of the data lines 114a-k and would further transmit an accompanying clock signal 210 over the strobe line 112. The second IC device 100b will phase lock to the clock signal 210, which is typically at a 50% duty cycle, and latch in the data 220 received from one of the data lines 114a-k using the clock signal 210. In practice, the data signal 220 will typically be of a higher frequency than the clock signal 210; thus, the receiving IC device 100b will phase lock to the clock signal 210 and generate a higher frequency multiple (e.g., 4×, 8×, etc.) of this clock signal 210 for latching in the data 220. The receiving IC device 100b utilizes the rising edge 215 of each clock cycle of clock signal 210 for phasing locking.

The interface circuitry 400a, 400b of the IC devices 100a, 100b, respectively, provides the necessary control and/or logic to establish the above-described source synchronous interface. However, the interface circuitry 400a, 400b of each IC device 100a, 100b further includes the necessary control and/or logic to both transmit and receive side-band data over the strobe line 112. To transmit side-band data, the interface circuitry 400a, 400b of each IC device 100a, 100b can insert, or modulate, side-band data onto a clock signal being transmitted over the strobe line 112. Likewise, to receive side-band data, the interface circuitry 400a, 400b of each IC device 100a, 100b can extract (demodulate) side-band data from a clock signal received on the strobe line 112. Any suitable circuitry and/or logic may be used to insert side-band data onto a clock signal and to extract side-band data from a received clock signal, and an exemplary embodiment of the interface circuitry 400a (or 400b) is described below. Also, although illustrated as forming a part of the IC devices 100a, 100b, respectively, it should be understood that the interface circuitry 400a, 400b may be located off-chip.

The transmission of side-band data on a source synchronous clock signal is achieved, in part, by decreasing the duty cycle of the clock signal (again, only the rising edge of each clock cycle is used by the receiving device for phase locking) and utilizing the additional time window for side-band data transmission. For example, with reference to FIG. 3 and returning to the above example wherein the first IC device 100a is transmitting data 220 to the second IC device 100b, a clock signal 210′ has a reduced duty cycle and side-band data 310 has been inserted onto this clock signal 210′. The receiving IC device 100b utilizes the rising edge 215′ of each clock cycle of clock signal 210′ for phasing locking. Once the receiving IC device 100b has locked onto the frequency of the clock signal 210′, the receiving IC device 100b can latch in the data 220—as well as the side-band data 310, which is extracted from the clock signal 210′—in response to the clock signal 210′ or a higher frequency multiple thereof.

The side-band data 310 specifies the type or class—e.g., header information, address data, control information, credit information, or start-of-data—of the data 220 accompanying the clock signal 210′. The side-band data 310 may comprise a pre-defined bit pattern, or token, that indicates a specific action that is to be taken with respect to the data 220. Also, although only one data signal 220 is illustrated in the example of FIG. 3, it should be understood that the side-band data 310 carried in a clock signal 210′ may describe or correspond to multiple data signals (that have been received on two or more of the data lines 114a-k).

By inserting the side-band data onto a clock signal and utilizing a strobe line to transmit this information, allocation of a data line to the transmission of such side-band data is no longer necessary. Thus, the bandwidth of the source synchronous interface between the IC devices 100a-b is improved. Also, by utilizing the strobe line 112 for side-band data, the number of data lines 114 may potentially be decreased, thereby reducing the on-chip real estate consumed by the strobe and data lines 112, 114a-k and, further, minimizing the frequency effects that may occur in high frequency applications.

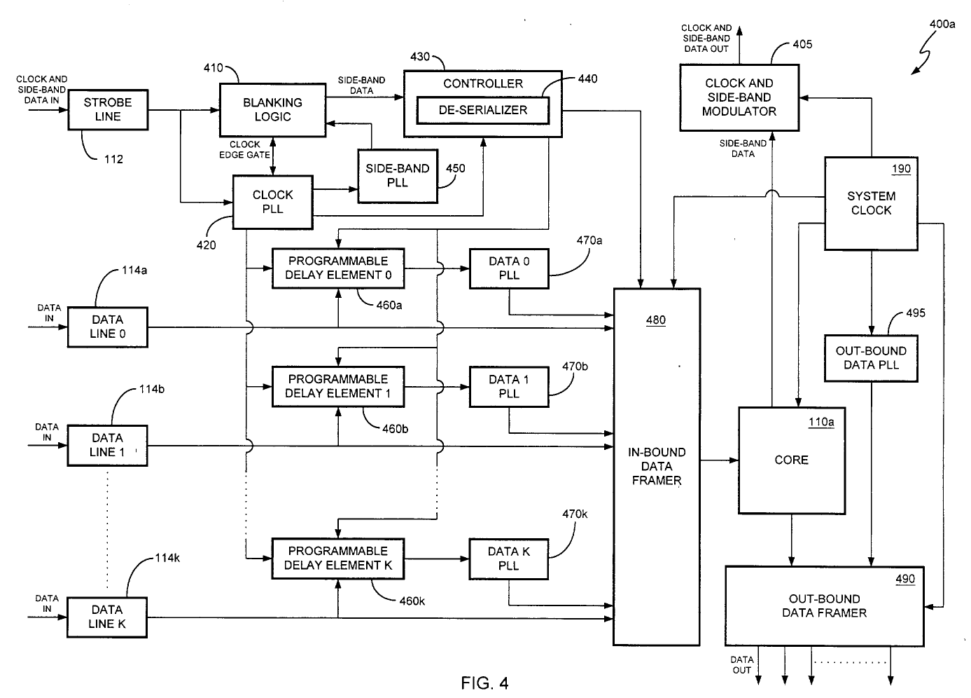

Referring to FIG. 4, a specific embodiment of the interface circuitry 400a (or 400b) of IC device 100a (or 100b) is illustrated. The interface circuitry 400a can insert side-band data into a source synchronous clock signal for transmission, and the interface circuitry 400a can, likewise, extract side-band data from a received source synchronous clock signal. As previously described, the interface circuitry 400a is coupled with each of the strobe line 112 and with each of the data lines 114a-k. Also, the interface circuitry 400a is coupled with the system clock 190 and with the core 110a of IC device 100a.

The interface circuitry 400a can transmit data over one of the data lines 114a-k and, as noted above, the interface circuitry 400a can modulate side-band data into a source synchronous clock signal that is to accompany the data. The interface circuitry includes an out-bound data framer 490 and, coupled therewith, an out-bound data PLL (phase-locked loop) 495. Generally, a PLL is an electronic device or circuit that can lock on to the frequency of a received signal and output a signal of matching frequency or of a higher frequency multiple thereof. Data is latched out of the core 110a in response to a system clock signal received from the system clock 190. The out-bound data framer 490 latches data out (onto data lines 114a-k) in response to a clock signal received from the out-bound data PLL 495, and the out-bound data PLL 495 may derive this clock signal from the system clock signal received from system clock 190. The out-bound data framer 490 converts parallel data received from core 110a to serial data for transmission, and a data signal including the data is provided to a data line 114 for transmission (contemporaneous with a source synchronous clock signal) to the receiving device (i.e., second IC device 100b). An exemplary data signal 220 is illustrated in FIG. 3.

The interface circuitry 400a includes a clock and side-band modulator 405, this element being coupled with the system clock 190. The clock and side-band modulator 405 generates a clock signal—which clock signal it may derive from a system clock signal received from system clock 190—that is to be transmitted on strobe line 112 contemporaneous with the data being transmitted on the data line (or lines) 114. The receiving device (i.e., IC device 100b) will phase lock on the rising edge of each clock cycle of this clock signal. The clock and side-band modulator 405 also receives side-band data from core 110a and inserts (modulates) the side-band data onto the clock signal. The combined signal—i.e., the source synchronous clock signal and side-band data, which will be referred to herein as the “clock and side-band data signal”—is provided to the strobe line 112 for transmission to the receiving device (i.e., second IC device 100b) along with the data signal. An exemplary clock and side-band data signal 210′ is shown in FIG. 3.

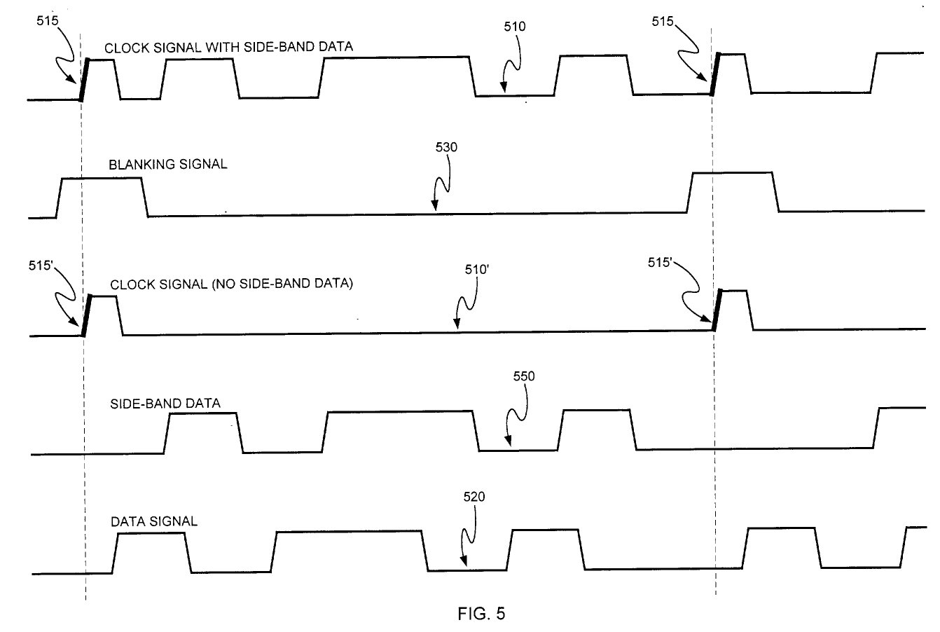

Referring now to FIG. 4 in conjunction with FIG. 5, the interface circuitry 400a can also receive a data signal 520 on one of the data lines 114a-k and a clock and side-band data signal 510 on the strobe line 112, and the interface circuitry 400a can, as noted above, extract the side-band data from the received clock signal 510. The data 520 received on a data line 114 is provided to an in-bound data framer 480. The in-bound data framer 480 converts serial data received from a data line 114 to parallel data for transmission to core 110a. The data 520 received on the data line 114 is latched into the in-bound data framer 480 in response to a clock signal received (by in-bound data framer 480) from a corresponding data PLL 470a-k, respectively. Operation of the data PLLs 470a-k will be explained in more detail below. The in-bound data framer 480 subsequently latches the data into the core 110a in response to a system clock signal received from the system clock 190.

The data signal 520 received on one of the data lines 114a-k is accompanied by a source synchronous clock signal 510 received at strobe line 112, the clock signal 510 having side-band data modulated thereon. The strobe line 112 is coupled with blanking logic 410 and a clock PLL 420. The blanking logic 410 generates a blanking signal 530. The blanking signal 530 comprises a series of pulses in synchronism with the clock cycles of the clock and side-band data signal 510. The blanking signal 530 is provided to the clock PLL 420, where this signal functions as a clock edge gate to enable the clock PLL 420 to “blank out” the side-band data from the clock and side-band data signal 510. Thus, the clock PLL 420 “sees” a clock signal 510′ without side-band data, thereby enabling the clock PLL 420 to lock on to the rising edge 515′ of each clock cycle. The blanking logic 410 may include a delayed-lock loop (DLL) to synchronize the blanking signal 530 with the received clock and side-band data signal 510. Generally, a DLL is an electronic device or circuit for performing fine grain synchronization between two signals.

As noted above, the clock PLL 420 phase locks to the rising edges 515′ of the clock signal 510′ (with no side-band data). The clock PLL 420 may then provide a clock signal to the side-band PLL 450 and to programmable delay elements 460a-k. The clock signal provided to the side-band PLL 450 (and programmable delay elements 460a-k) may be a higher frequency multiple (e.g., 4×, 8×, etc.) of the clock signal 510′ that the clock PLL 420 has locked on to. The respective functions of the side-band PLL 450 and programmable delay elements 460a-k will be explained below.

The blanking signal 530 is also used to gate the side-band data into a de-serializer 440, thereby extracting (demodulating) a side-band data signal 550 from the clock and side-band data signal 510. The de-serializer 440, which may form part of a controller 430, converts the serial side-band data 550 to parallel data for use by in-bound data framer 480. The side-band data 550 is latched into the de-serializer 440 (or controller 430) based upon a clock signal provided by the side-band PLL 450. The side-band PLL 450 locks onto the clock signal received from the clock PLL 420, as described above, and the side-band PLL 450 may generate a higher frequency multiple of this signal to latch the side-band data 550 into the de-serializer 440.

As set forth above, data 520 received on one of the data lines 114a-k is latched into the in-bound data framer 480 in response to a clock signal received from a corresponding data PLL 470a-k. For example, if the data signal 520 is received on data line 114b (DATA LINE 1), the data 520 is latched into the in-bound data framer 480 in response to a signal received from the data PLL 470b (DATA 1 PLL). The data PLLs 470a-k lock onto a signal provided by a corresponding programmable delay element 460a-k, respectively. Continuing from the above example, the data PLL 470b (DATA 1 PLL) would lock on to a signal provided by the programmable delay element 460b (PROGRAMMABLE DELAY ELEMENT 1).

Each programmable delay element 460a-k stores a timing offset value representing a skew between an incoming data signal and the incoming clock signal. For example, the programmable delay element 460b (PROGRAMMABLE DELAY ELEMENT 1) may store a timing offset value corresponding to the skew between a data signal 520 received on data line 114b (DATA LINE 1) and a clock and side-band data signal 510 received on strobe line 112. Data signals received on the data lines 114a-k may exhibit varying times-of-flight between the transmitting and receiving devices (e.g., IC devices 100b, 100a) as compared to the time-of-flight of a signal on strobe line 112. The timing offset values provided by the programmable delay elements 460a-k, respectively, provides a mechanism to null out this data line-to-clock edge skew, thereby compensating for these time-of-flight differences. Each programmable delay element 460a-k can receive the clock signal 510′ (without side-band data), or a frequency multiple thereof, and apply its stored timing offset value to this received clock signal in order to provide a corrected (i.e., with skew effects minimized) clock signal to its corresponding data PLL 470a-k.

The programmable delay elements 460a-k may be programmed with the appropriate timing offset value by employing a “training” phase or program. During a training phase, a series of training waveforms are transmitted over the data lines 114a-k in order to “train” or program the appropriate timing offset values into the programmable delay elements 460a-k. The data PLLs 470a-k will lock on to the rising edges of a clock signal received from the clock PLL 420, and the programmable delay elements 460a-k will determine a timing offset value that nulls out any data line-to-clock edge skew. These timing offset values may then be stored in the programmable delay elements 460a-k, respectively. Alternatively, the controller 430 may program the programmable delay elements 460a-k based upon, for example, control data (a type of side-band data) extracted from a received clock and side-band data signal 510. A training program may also be used to determine the correct timing for the blanking signal 530, such that the blanking signal 530 is in synchronism with the rising edges 515 of the received clock signal 510.

The interface circuitry 400a illustrated in FIGS. 4 and 5 and the accompanying text is intended to represent an exemplary embodiment of the interface circuitry 400a (or 400b). It should be understood that any suitable circuitry and/or logic may be utilized in the IC devices 100a, 100b of FIG. 1 to transmit and receive side-band data over a source synchronous clock signal. Further, it should be understood that the interface circuitry 400a of FIG. 4 may be employed in any type IC device (e.g., a controller, a memory device, a processing device, etc.), as noted above.

The foregoing detailed description and accompanying drawings are only illustrative and not restrictive. They have been provided primarily for a clear and comprehensive understanding of the disclosed embodiments and no unnecessary limitations are to be understood therefrom. Numerous additions, deletions, and modifications to the embodiments described herein, as well as alternative arrangements, may be devised by those skilled in the art without departing from the spirit of the disclosed embodiments and the scope of the appended claims.

What is claimed is:

1. A method comprising:
transmitting a data signal on a first signal line;
transmitting a clock signal on a second signal line, the clock signal including side-band data corresponding to the data signal.

2. The method of claim 1, wherein each of the first signal line and the second signal line comprises an electrically conductive path.

3. The method of claim 1, wherein the side-band data identifies the data signal as one of header data, address data, control data, and credit data.

4. A method comprising:
transmitting a data signal on a first signal line;
inserting side-band data onto a clock signal to create a modulated clock signal, the side-band data corresponding to the data signal; and
transmitting the modulated clock signal on a second signal line.

5. The method of claim 4, wherein each of the first signal line and the second signal line comprises an electrically conductive path.

6. The method of claim 4, wherein the side-band data identifies the data signal as one of header data, address data, control data, and credit data.

7. A method comprising:
receiving a first signal including data;
receiving a second signal including a clock and side-band data, the side-band data corresponding to the data; and
extracting the side-band data from the second signal.

8. The method of claim 7, further comprising extracting the clock from the second signal.

9. The method of claim 8, further comprising latching the data using the clock.

10. The method of claim 8, further comprising:
generating another clock that is a higher frequency multiple of the clock; and
latching the data using the higher frequency clock.

11. The method of claim 8, further comprising:
generating a second clock based upon the clock; and
latching the side-band data using the second clock.

12. The method of claim 11, wherein the second clock is a higher frequency multiple of the clock.

13. A method comprising:
receiving a first signal including data;
receiving a second signal including a clock and side-band data, the side-band data corresponding to the data;
generating a blanking signal in synchronism with the clock;
blanking the side-band data from the second signal with the blanking signal to extract the clock; and
in response to the blanking signal, gating the side-band data from the second signal to extract the side-band data.

14. The method of claim 13, further comprising latching the data based upon the extracted clock.

15. The method of claim 14, further comprising latching the data based upon a higher frequency multiple of the extracted clock.

16. The method of claim 13, further comprising:
generating a second clock based upon the extracted clock; and
latching the side-band data based upon the second clock.

17. The method of claim 16, wherein the second clock comprises a higher frequency multiple of the extracted clock.

18. A device comprising:
a core; and
interface circuitry coupled with the core, the interface circuitry to
transmit a data signal on a data line,
insert side-band data onto a clock signal to create a modulated clock signal, the side-band data corresponding to the data signal, and
transmit the modulated clock signal on a strobe line.

19. The device of claim 18, wherein the side-band data identifies the data signal as one of header data, address data, control data, and credit data.

20. The device of claim 18, wherein each of the data line and the strobe line comprises an electrically conductive path.

21. A device comprising:
a core; and
interface circuitry coupled with the core, the interface circuitry to
receive a first signal on a data line, the first signal including data,
receive a second signal on a strobe line, the second signal including a clock and side-band data, the side-band data corresponding to the data, and
extract the side-band data from the second signal.

22. The device of claim 21, wherein the side-band data identifies the data as one of header data, address data, control data, and credit data.

23. The device of claim 21, the interface circuitry to extract the clock from the second signal.

24. The device of claim 23, the interface circuitry to latch the data using the clock.

25. The device of claim 23, the interface circuitry to:
generate another clock that is a higher frequency multiple of the clock; and
latch the data using the higher frequency clock.

26. The device of claim 23, the interface circuitry to:
generate a second clock based upon the clock; and
latch the side-band data using the second clock.

27. The device of claim 26, wherein the second clock is a higher frequency multiple of the clock.

28. An apparatus comprising:
a bus;
a first device coupled with the bus;
a second device coupled with the bus;
first interface circuitry coupled with the first device, the first interface circuitry to transmit a first signal and a second signal over the bus, the first signal including data, the second signal including a clock and side-band data, the side-band data corresponding to the data; and
second interface circuitry coupled with the second device, the second interface circuitry to receive the first signal and the second signal, the second interface circuitry to extract the side-band data from the second signal.

29. The apparatus of claim 28, the second interface circuitry to extract the clock from the second signal.

30. The apparatus of claim 29, the second interface circuitry to latch the data using the clock.

31. The apparatus of claim 29, the second interface circuitry to:
generate another clock that is a higher frequency multiple of the clock; and
latch the data using the higher frequency clock.

32. The apparatus of claim 29, the second interface circuitry to:
generate a second clock based upon the clock; and
latch the side-band data using the second clock.

33. The apparatus of claim 32, wherein the second clock is a higher frequency multiple of the clock.

34. The apparatus of claim 28, wherein the first interface circuitry comprises part of the first device.

35. The apparatus of claim 34, wherein the second interface circuitry comprises part of the second device.

36. The apparatus of claim 28, wherein the first device comprises a controller and the second device comprises a memory device.

37. The apparatus of claim 36, wherein the second device comprises a DRAM memory.

38. An article of manufacture comprising:
a medium having content that, when accessed by a device, causes the device to
transmit a data signal on a first signal line;
transmit a clock signal on a second signal line, the clock signal including side-band data corresponding to the data signal.

39. The article of manufacture of claim 38, wherein each of the first signal line and the second signal line comprises an electrically conductive path.

40. The article of manufacture of claim 38, wherein the side-band data identifies the data signal as one of header data, address data, control data, and credit data.

41. An article of manufacture comprising:
a medium having content that, when accessed by a device, causes the device to
receive a first signal including data;
receive a second signal including a clock and side-band data, the side-band data corresponding to the data; and
extract the side-band data from the second signal.

42. The article of manufacture of claim 41, wherein the content, when accessed, further causes the device to extract the clock from the second signal.

43. The article of manufacture of claim 42, wherein the content, when accessed, further causes the device to latch the data using the clock.

44. The article of manufacture of claim 42, wherein the content, when accessed, further causes the device to:
generate another clock that is a higher frequency multiple of the clock; and
latch the data using the higher frequency clock.

45. The article of manufacture of claim 42, wherein the content, when accessed, further causes the device to:
generate a second clock based upon the clock; and
latch the side-band data using the second clock.

46. The article of manufacture of claim 45, wherein the second clock is a higher frequency multiple of the clock.
